(19) United States
(12) Patent Application Publication
(10) Pub. No.: US 2005/0277748 A1
(43) Pub. Date: Dec. 15, 2005

(54) Method of liquid phase polymerization

(75) Inventors: Hitoshi Kimoto, Sodegaura-shi (JP); Kazuyuki Takemura, Ichihara-shi (JP); Kojiro Matsui, Houston, TX (US)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/131,429

(22) Filed: May 18, 2005

(30) Foreign Application Priority Data
May 20, 2004 (JP) 2004-150076

(51) Int. Cl. C08F 2/00

(52) U.S. Cl. 526/74

(57) ABSTRACT

Disclosed is a method for producing an olefin polymer by liquid phase polymerization, the method including a step of polymerizing an olefinic monomer system in the presence of a catalyst and a liquid medium in a polymerization reactor, wherein the reactor has an inner wall having an arithmetic average surface roughness of 1.0 μm or less.

### BACKGROUND OF THE INVENTION

1. Field of the Invention

The present invention relates to a method for producing olefin polymers. Particularly, the invention relates to a liquid phase method for producing olefin polymers which reduces reactor fouling in a liquid phase olefin polymerization process so as to allow continuous operation with stability.

2. Description of the Related Art

In the production of polyolefin by liquid phase polymerization in a reactor, a polymer formed may adheres on the inner surface of the reactor during the polymerization and, as a result, causes reduction in heat transfer coefficient of the wall of the reactor so that it may become impossible to cool the reaction system sufficiently through the wall of the reactor. Various improvements, therefore, have been made.

The following are examples of techniques proposed for preventing reactors from fouling during liquid phase polymerization.

WO96/11961 discloses a method for polymerizing olefin using a catalyst composed of a catalytic component supported on a porous carrier.

JP-A No. 2002-37812 discloses a polymerization method conducted in the presence of an olefin polymerization catalyst including an ion-exchangeable laminar silicate treated with concentrated acid under special conditions.

U.S. Pat. No. 5,959,045 discloses a method for producing polyketone by liquid phase polymerization wherein a reactor having an inner wall which has been polished or coated.

Under such circumstances, an object of the present invention is to prevent, during olefin polymer production by liquid phase polymerization conducted in a reactor, a resulting polymer from fouling the inner surface of the reactor. The invention intends to propose a liquid phase method for producing olefin polymers which enables a stable, continuous operation of an olefin polymer production process.

### SUMMARY OF THE INVENTION

In one aspect of the present invention, provided is a method for producing an olefin polymer by liquid phase polymerization, the method including a step of polymerizing an olefinic monomer system in the presence of a catalyst and a liquid medium in a polymerization reactor, wherein the reactor has an inner wall having an arithmetic average surface roughness of 1.0 μm or less.

### DESCRIPTION OF THE PREFERRED EMBODIMENTS

Methods of the present invention can be applied widely to various types of liquid phase polymerization carried out in a liquid medium in the presence of a catalyst, such as bulk polymerization and slurry polymerization. Methods of the present invention may be applied to liquid phase polymerization which is carried out alone. Alternatively, in a polymerization process composed of two or more polymerization steps which include one or more liquid phase polymerization steps and which may optionally include one or more gas phase polymerization steps, methods of the present invention may be carried out as any of the liquid phase polymerization step(s).

In methods of the present invention, the olefinic monomer system may be composed of either a single kind of monomer or a combination of two or more kinds of monomers. Examples of olefinic monomers which can be used in methods of the present invention include ethylene, propylene, 1-butene, 1-pentene, 1-hexene and 1-octene. Preferable examples are ethylene, propylene, 1-butene and 1-hexene. Particularly preferable examples include ethylene, propylene and 1-butene.

In methods of the present invention, the polymerization of a monomer system is carried out in the presence of a liquid medium. Examples of the liquid medium include inert solvents such as saturated hydrocarbons, e.g. butane and hexane. Monomers to be polymerized may also be used as a liquid medium.

In methods of the present invention, the polymerization of a monomer system is carried out in the presence of a catalyst. Examples of the catalyst include stereoregulating catalysts composed of (1) a solid catalyst component composed of transition metal components such as titanium and magnesium, (2) an organometal compound such as organoaluminum compounds and optionally (3) an electron-donating compound such as organosilicon compounds.

In methods of the present invention, the liquid phase polymerization is carried out in a polymerization reactor having an inner surface whose arithmetic mean surface roughness is 1.0 μm or less (preferably 0.8 μm or less). It is desirable that the value of the arithmetic mean surface roughness be as small as possible. By conducting the liquid phase polymerization in such a reactor, it is possible to prevent a polymer formed from adhering to the inner surface of the reactor. As a result, it is possible to inhibit reduction in overall heat transfer coefficient of the wall of the reactor during the polymerization.

Methods of the present invention may be carried out using various types of reactors for liquid phase polymerization. In particular, loop reactors may suitably be employed.

The arithmetic mean surface roughness used herein is defined in Japanese Industry Standard (JIS) B0601 and is determined using a commercially available surface roughness analyzer (for example, a contact type three-dimensional surface roughness analyzer) in accordance with JIS B0601.

The material forming the inner surface of the reactor may be either stainless steel or carbon steel. For practicing methods of the present invention, the inner surface of a reactor to be used may be smoothened by polishing, plating or other appropriate technique so that the inner surface comes to have an arithmetic mean surface roughness of 1.0 μm or less, preferably 0.8 μm or less. The polishing may be effected by buffing or electrolytic polishing. The buffing is a technique of mechanically smoothening a material surface by cutting or plastic deformation. Electrolytic polishing is a technique of smoothening a material surface by utilizing chemical or electrochemical dissolution of the material surface. Plating, which is normally used for improving corrosion resistance or abrasion resistance of a material surface, is suitably used for practicing methods of the present invention. For example, electroless nickel plating, which may be called Kanigen nickel plating, for depositing nickel alloy to a material surface may be used.

In the present invention, the method for adjusting the arithmetic mean surface roughness is not restricted to those mentioned above and any method which can achieve an arithmetic mean surface roughness of 1.0 μm or less (preferably 0.8 μm or less) may be employed appropriately depending on the material of the reactor, properties of the reaction system, which may be solution, suspension or slurry, and polymerization conditions.

Other polymerization conditions including polymerization temperature, polymerization pressure and polymerization time may be adjusted appropriately on the basis of knowledge of those skilled in the art.

### EXAMPLE

The present invention will be described in more detail by way of an example and a comparative example. It should be noted that the scope of the invention, however, is not limited to the example.

[Measurement of Arithmetic Mean Surface Roughness of Inner Surface of Reactor]

In the following Example and Comparative Example, the arithmetic mean surface roughness of the inner surface of a reactor was determined by a method described below.

Onto a measurement site of the inner wall of the reactor, a mixture prepared by (1) combining components A and B of a commercially available impression cement (trade name: Replica DMR-503; available from Ishikawajima Inspection & Instrumentation Co., Ltd.) in a weight ratio 1:1 and (2) fully mixing both components was applied in a thickness about 5 mm while the mixture was still soft.

After the applied cement fully solidified, it was removed from the measurement site. Thus, a cement piece was obtained that had a surface to which the profile of the inner surface of the reactor was transferred accurately.

In accordance with JIS B0601, the profile of the surface of the cement piece was analyzed by means of a contact type three-dimensional surface roughness analyzer (trade name: SURFTEST 701.3D; manufactured by Mitsutoyo) and the arithmetic mean surface roughness (Ra) of the surface of the cement piece was determined. The Ra determined for the cement piece was used as the arithmetic mean surface roughness of the inner surface of the reactor.

[Determination of Overall Heat Transfer Coefficient]

The overall heat transfer coefficient of the wall of a reactor was determined using the following equation [1]:
U=W·ρ·Ln((Tp−T1)/(Tp−T2))/A [1]
wherein U is the overall heat transfer coefficient (kcal/m²·hr·° C.), W is the amount of cooling water used for removal of the heat of the reactor (m³/hr), ρ is the density of cooling water (kg/m³), T1 is the temperature of cooling water at the inlet (° C.), T2 is the temperature of cooling water at the outlet (° C.), Tp is the temperature in the reactor (° C.), and A is the heating surface area of the reactor.

### Example

A carbon steel loop reactor for liquid phase polymerization was prepared. The inner surface of the reactor was finished by a combination of buffing and subsequent electroless nickel plating. The arithmetic mean surface roughness of the polished surface was measured to be 0.5 to 1.0 μm.

Using the surface-finished reactor, copolymerization of propylene and 1-butene was carried out in the presence of a stereoregulating catalyst composed of (1) a solid catalyst component containing titanium and magnesium, (2) an organoaluminum compound and (3) an organosilicon compound under conditions: polymerization temperature 52° C., polymerization pressure 3.3 MPa and slurry concentration 0.1 kg-solid/kg-slurry.

The overall heat transfer coefficient of the reactor wall measured just after the start of the polymerization was 1400 kcal/m²·hr·° C. During a period of about four months from the start of the polymerization, it was able to continue the polymerization with stability at overall heat transfer coefficients from about 1200 kcal/m²·hr·° C. to about 1300 kcal/m²·hr·° C.

### Comparative Example

Slurry polymerization was carried out in the same manner as that in Example except using a non-surface-finished carbon steel loop reactor having an inner surface whose arithmetic mean surface roughness of from 1.5 μm to 2.0 μm.

The overall heat transfer coefficient of the reactor wall measured just after the start of the polymerization was 1100 kcal/m²·hr·° C., which decreased to about 700 kcal/m²·hr·° C. within one month from the start of the polymerization. Moreover, it decreased to about 200 kcal/m²·hr·° C. and it became impossible to continue the polymerization within two months from the start of the polymerization.

1. A method for producing an olefin polymer by liquid phase polymerization, the method comprising a step of polymerizing an olefinic monomer system in the presence of a catalyst and a liquid medium in a polymerization reactor, wherein the reactor has an inner wall having an arithmetic average surface roughness of 1.0 μm or less.
